(19) United States
(12) Patent Application Publication
(10) Pub. No.: US 2007/0101847 A1
(43) Pub. Date: May 10, 2007

(54) Paper perforator mechanism

(75) Inventor: Fumio Shimizu, Tokyo (JP)

Correspondence Address: WOOD, PHILLIPS, KATZ, CLARK & MORTIMER, 500 W. MADISON STREET, SUITE 3800, CHICAGO, IL, 60661, US

(73) Assignee: Carl Manufacturing Co., Ltd.

(21) Appl. No.: 11/542,784

(22) Filed: Oct. 4, 2006

(30) Foreign Application Priority Data
Oct. 7, 2005 (JP) 2005-294787

(51) Int. Cl. B26D 5/42; B26D 7/02

(52) U.S. Cl. 83/614; 83/386; 83/455

(57) ABSTRACT

There is provided a paper perforator mechanism which includes: a base; a paper processing main device working for cutting, perforating or stapling to papers, wherein the paper processing main device is placed on the base; a paper adjuster projectable from the upper surface of the base, wherein the end of the papers, where facing to the paper processing main device, is abutted to the paper adjuster; a slide plate slidable on the base; a paper presser provided on the slide plate and pressable to the papers placed on the side plate; a first positioning means setting an initial position of the slide plate on the base relative to the paper adjuster; a depressing means depressing the paper adjuster to contain within the base; a sliding means moving the slide plate, on which the papers are fixed, toward the paper processing main device; a second positioning means setting the position of the slide plate on the base in a condition that the papers are ready for being processed.

### BACKGROUND OF THE INVENTION

1. Field of the Invention

The present invention relates to a paper perforator mechanism wherein a paper processing main device is provided on a base, and particularly to a paper perforator mechanism wherein a paper processing main device itself involves performances of a paper cutting, a perforation, stapling, etc.

2. Description of the Related Art

In a conventional paper perforator, in case that a plural number of papers are cut, perforated or stapled, the papers need to be arranged at first relative to a main device. Regarding how to arrange the papers relative to the main device, there are several examples such as: abutting the end of the papers (at the side the papers are inserted) to a dead-end portion provided within the main device; setting the end of the papers (opposite to the inserted side) at a scale provided on a base, etc.

A punched apparatus of a patent reference 1 (Japanese Patent Application Laid-open No. H10-15899), for example, discloses the apparatus, in which the end of papers (at the side the papers are inserted) abuts to a dead-end portion provided within a main device that perforates the papers. On the other hand, a paper cutter of a patent reference 2 (Japanese Patent Application Laid-open No. H11-333788) discloses the cutter, which sets the end of papers (opposite to the side that the papers are inserted) to a scale provided on a base.

Here, a number of paper processed may be singular or may be plural. Through this specification “the papers” means at least one piece of paper.

FIG. 24 shows a conventional punched apparatus 60 disclosed in the patent reference 1, in a partial sectional view. A base 65 of the punched apparatus 60 is provided with a die 67 with a hole as a cutting edge, and a bracket 66 standing upright therefrom.

Between the die 67 and a guide 68 fixed thereto, a clearance 70 is formed so that the papers are insertable thereinto for perforation. In the clearance 70 the dead-end portion 71 is formed. The maximum thickness of the papers to be inserted would be restricted according to the space of the clearance 70, and the position in which the papers are processed (such as cutting, perforation, etc.) would be dependent on where the dead-end portion 71 is provided.

A punching blade 61 is movable only in a vertical direction due to the guide 68. The punching blade 61 can be pressed down according to a descent of a presser 63. The papers inserted into the clearance 70 can be perforated by a shearing force created between the cutting edge of the punching blade 61 and the die 67. Paper waste produced through the perforated procedure is dischargeable into a waste receiver 73 placed beneath the die 67, by passing through a hole of the die 67.

FIG. 25 shows a conventional paper cutter (perspective view) disclosed in the patent reference 2. In a paper cutter 80, a cutting device 81 is placed on a plate-like and rectangular base 82. The cutting device 81 is composed of a rail 83 provided going along one long side of the base 82, and a slider 86 with a rotary knife, which slides along the rail 83.

Further, on the base 82 two pieces of guiding rulers 87, which are perpendicular to the rail 83, are placed, running parallel with each other. A paper adjuster 88 is laid across the guiding rulers 87; the paper adjuster 88 is movable along the guiding rulers 87.

In paper cutting procedures, the position of the paper adjuster 88 is adjusted according to the size of the papers; the paper adjuster 88 restricts the back end of the papers. After the papers are restricted, the paper adjuster 88 is fixed to the guiding rulers 87. One side of the rail 83 is pivotally supported by a holder 90. By rotating the other side of the rail 83 upward, a clearance is made between the rail 83 and base 82, so that the papers can be inserted thereinto. The back end of the papers placed over the base 82 abuts to the paper adjuster 88, positioning the papers.

In a condition that the rail 83 is tilted, an engaging claw 85 at the tip of the rail 83 engages with an engaging portion 84 provided on the base 82. The papers are thus fixed between the upper surface of the base 82 and a paper presser 89 provided beneath the rail 83. The slider 86 is then moved along the rail 83; the papers are cut with a rotary knife held within the slider 86.

According to the punched apparatus 60 of the patent reference 1, the dead-end portion 71 is formed within the punched apparatus 60, thereby inhibits the user from visually positioning the papers, often causing the misplacement of the papers. Further, if paper wastes accidentally enter the dead-end portion 71, the number of papers to be inserted may be limited. Misplacement or slanting of the papers may also happen.

On the other hand, according to the paper cutter 80 of the patent reference 2, the papers are positioned at the end thereof. Here, although the front end of the papers is subject to the cutting procedure, the accurate positioning of the papers would be hampered especially when the user needs to deal with the papers in different standard sizes.

Accordingly, before the papers are placed on the base 82, the front end of the papers, which is subject to the paper cutting, etc., should be arranged; however, it is, as said, difficult to place the papers on the base 82 while keeping the arrangement if dealt with the different standard sizes. The front end of the papers is usually dislocated when placed on the base 82.

### SUMMARY OF THE INVENTION

The present invention has been made in light of the above problem, and it is an object of the present invention to provide a paper perforator mechanism, allowing the user to visually arrange papers on a base, regardless of paper standard sizes, and to maintain its arrangement until the papers are ready for perforation at a paper processing main device.

In order to achieve the object described above, according to a first aspect of the present invention, there is provided a paper perforator mechanism which includes: a base; a paper processing main device working for cutting, perforating or stapling to papers, wherein the paper processing main device is placed on the base; a paper adjuster projectable from the upper surface of the base, wherein the end of the papers, where facing to the paper processing main device, is abutted to the paper adjuster; a slide plate slidable on the base; a paper presser provided on the slide plate and pressable to the papers placed on the side plate; a first positioning means setting an initial position of the slide plate on the base relative to the paper adjuster; a depressing means depressing the paper adjuster to contain within the base; a sliding means moving the slide plate, on which the papers are fixed, toward the paper processing main device; a second positioning means setting the position of the slide plate on the base in a condition that the papers are ready for being processed.

With these structures, the user can visually position the end of the papers facing the paper processing main device (hereinafter refer to as insertion side of the papers) by abutting to the paper adjuster. The positioned papers can be fixed on the slide plate, the position of which is restricted by the first positioning means relative to the paper adjuster. By sliding the slide plate to the position restricted by the second positioning means, the papers fixed on the slide plate can be precisely located at the paper processing main device where paper perforations are performed. This means that the distance between the end of the insertion side of the papers and a processing position (the exact position in which perforations, etc. are performed) can be determined at precise.

Further, when the papers are moved to a given position where appropriate for perforations, etc., the slide plate is made to be stopped by the second position means, contributing to perforations, etc. at a precise position. Still further, the papers arranged by the user can be firmly fixed on the slide plate positioned in the initial position, and the slide plate is then moved to the position where perforations, etc. are performed. Accordingly, the user can keep the arrangement of the papers until the papers are processed.

In the first aspect of the present invention, the first positioning means may include: a position controlling means fixng the slide plate in the initial position; and a releasing means releasing the slide plate from the initial position. The present invention can thus position the slide plate in the initial position easily and precisely, and can release the slide plate from the initial position without any hampers.

In the first aspect of the present invention, the position controlling means may be provided with a step formed on a lever which is connected with the paper adjuster, wherein the slide plate is fixed in the initial position by abutting the end thereof to the step. With this structure the slide plate can be easily and surely positioned in the initial position.

In the first aspect of the present invention, the lever may be energized upward with a first elastic member; the releasing means may be provided with a projection placed downward from the paper presser; the surface of the lever, on which the step is provided, may be pressed downward against the spring force of the first elastic member with the projection so as to release the engagement of the step and the slide plate. Here, because the lever is pressed against the elastic member, the slide plate can be not only released from the initial position, but also the released condition can be maintained while the slide plate is moved. Further, by adjusting the length of the projection, the width of the space created between the paper presser and the slide plate can be modified. Accordingly, when the slide plate, on which the papers are fixed, is moved toward the paper processing main device, the operation releasing the slide plate from the initial position and the operation depressing the paper adjuster inside the base can be concurrently performed. The slide plate can be thus moved smoothly toward the paper processing main device.

In the first aspect of the present invention, the paper adjuster may be provided with an adjusting portion projectable from the surface of the base, and a controlled portion which controls an amount of the projection of the adjusting portion, wherein the controlled portion may be abutted to a guide provided on the base by the spring force of the second elastic member; and the releasing means may concurrently serve for the depressing means wherein by depressing the upper surface of the lever with the projection while depressing the second elastic member, the abutment between the controlled portion and the guide may be released, making the paper adjuster contained within the base. With this structure, the slide plate in the initial position can be smoothly released by means of the projection; the paper adjuster can be depressed to contain within the base; and most importantly, the release of the slide plate in the initial position and the depression of the paper adjuster within the base can be well maintained while the slide plate is moved.

In the first aspect of the present invention, the position controlling means may be formed as a surface provided at the end of the base where opposite to the place that the paper processing main device is provided, wherein the slide plate is fixed in the initial position by abutting the end thereof to the surface. With this structure, the slide plate may be set in the initial position by means of both the step formed on the lever and the surface.

In the first aspect of the present invention, the first positioning means may be formed as a scale, setting the paper adjuster as a datum starting point, and running parallel to the direction in which the side plate is moved. With this structure, the end of the papers can be arbitrarily set, so that the user can determine the exact place of the papers on which perforations, etc. are actually performed regardless that the user use different standard sizes at the same time.

In the first aspect of the present invention, a plurality of ratchet teeth running parallel to the scale and a ratchet claw may be provided facing to each other, either on the base or the side plate, wherein the ratchet teeth and the ratchet claw are engageable with each other by making the ratchet claw projectable from the base or the side plate. With this structure, the slide plate can be firmly fixed when the papers are abutted to the paper adjuster. The ratchet claw, on the other hand, can be easily released from the ratchet teeth by moving the slide plate, so that the user feels any hampers when starting to slide the slide plate.

In the first aspect of the present invention, the second positioning means may be provided as a stopping portion formed on a given portion of the base, wherein the slide plate is positioned by abutting the end thereof, where facing to the paper processing main device, to the stopping portion. Accordingly, regardless of the simple structure, the slide plate can be firmly fixed in a given position.

In the first aspect of the present invention, the sliding means may include the mechanism that a lock plate is shifted downward to press the paper presser toward the slide plate, and that the slide plate pressed by the paper presser is moved. With this structure, the papers can be fixed smoothly on the slide plate. Further, when fixing the papers on the slide plate, the fixation to the slide plate by the position controlling means is released, and the paper adjuster is depressed within the base at the same time. The slide plate, on which the papers are fixed, can be moved toward the paper processing main device without any additional procedures.

### BRIEF DESCRIPTION OF THE DRAWINGS

FIG. 1 is a full perspective view of a paper processing apparatus according to a first embodiment of the present invention;

FIG. 2 is a longitudinal sectional view showing main parts of a paper processing main device and a base according to a first embodiment of the present invention;

FIG. 3 is a partial front sectional view showing main parts of the paper processing main device according to a first embodiment of the present invention;

FIG. 4 is a partial sectional view that a slider is cut in half according to a first embodiment of the present invention;

FIG. 5 is a top view of the base according to a first aspect of the present invention;

FIG. 6 is a front view of the base according to a first aspect of the present invention;

FIG. 7 is a side view of the base according to a first aspect of the present invention;

FIG. 8 is a partial front sectional view of the base according to a first aspect of the present invention;

FIG. 9 is a partial front sectional view of the base according to a first aspect of the present invention;

FIG. 10 is a partial longitudinal sectional view laterally showing main parts of a slide plate according to a first aspect of the present invention;

FIG. 11 is a partial longitudinal sectional view laterally showing another main parts of the slide plate according to a first aspect of the present invention;

FIG. 12 is a longitudinal sectional view showing main parts of a paper presser in a condition that the paper presser is pressed according to a first aspect of the present invention;

FIG. 13 is a longitudinal sectional view showing another main parts of the paper presser in a condition that the paper presser is pressed according to a first aspect of the present invention;

FIG. 14 is a longitudinal sectional view showing main parts of the paper presser in a condition that the paper presser is slided according to a first aspect of the present invention;

FIG. 15 is a longitudinal sectional view showing another main parts of the paper presser in a condition that the paper presser is slided according to a first aspect of the present invention;

FIG. 16 is a full perspective view of the paper processing apparatus according to a second aspect of the present invention;

FIG. 17 is a partial longitudinal sectional view laterally showing main parts of the slide plate according to a second aspect of the present invention;

FIG. 18 is a longitudinal sectional view showing main parts of the paper presser in a condition that the paper presser is pressed according to a second aspect of the present invention;

FIG. 19 is a schematic perspective view mainly showing an arrangement of ratchet teeth and ratchet claws according to a second aspect of the present invention;

FIG. 20 is a longitudinal sectional view mainly showing a condition in that the paper presser is not pressed according to a third aspect of the present invention;

FIG. 21 is a longitudinal sectional view mainly showing a condition in that the paper presser is pressed according to a third aspect of the present invention;

FIG. 22 is a longitudinal sectional view mainly showing another condition in that the paper presser is pressed according to a second aspect of the present invention;

FIG. 23 is a top view of the base with another embodiment of a paper adjuster according to a first aspect of the present invention;

FIG. 24 is a partial sectional view laterally showing a conventional punched device;

FIG. 25 is perspective view of a conventional paper cutter;

FIG. 26 is the same with the FIG. 17 except for a surface not included; and

FIG. 27 is the same with the FIG. 18 except for the surface not included.

### DETAILED DESCRIPTION OF THE PREFERRED EMBODIMENTS

Preferred embodiments of the present invention will be described with reference to the accompanying drawings.

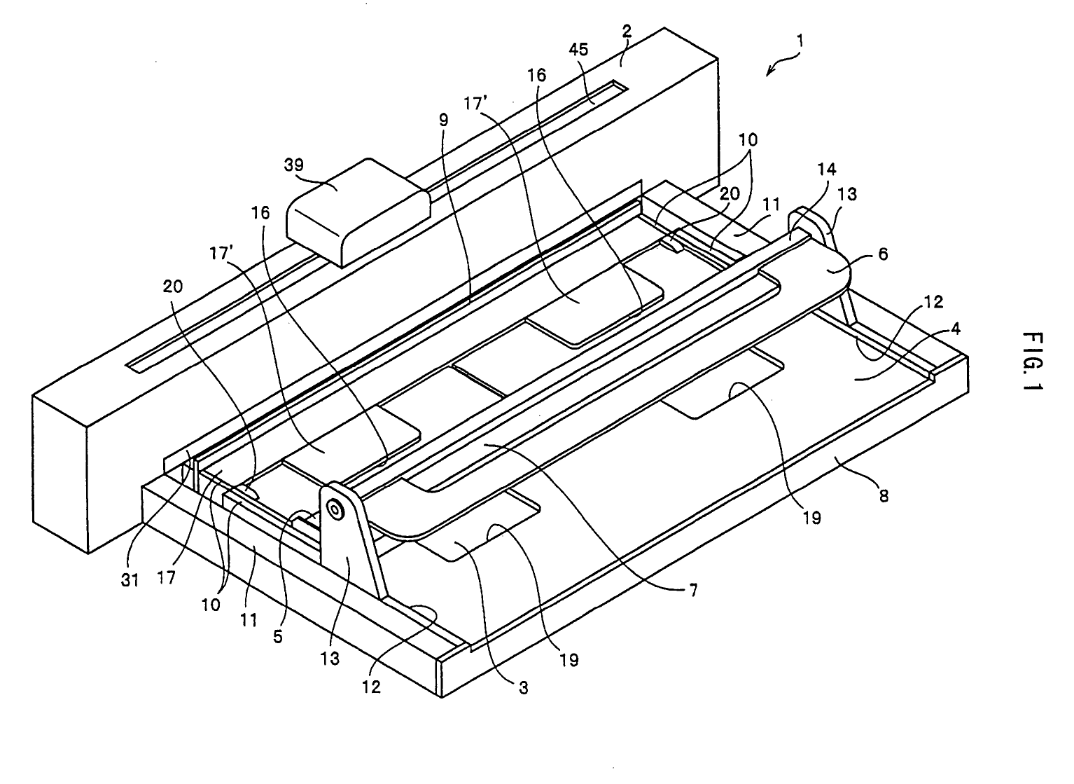

Hereinafter describes an Embodiment 1. As shown in FIG. 1, a paper processing apparatus 1 is composed of a base 3, on which papers are placed, and a paper processing main device 2 (hereinafter refer to as a main device 2) with a porous punch. For making an explanation easier, in a top view of the paper processing apparatus 1, a longitudinal direction of the main device 2 refers to a lateral direction, and a direction orthogonal to the lateral direction refers to a lengthwise direction. A direction perpendicular to the surface of the base 3 refers to a vertical direction.

A slide plate 4 is provided on the base 3 wherein the slide plate 4 is guided by a guide rib 25 formed on the base 3 (see FIG. 8). The slide plate 4 is movable on the base 3 in a lengthwise direction, so that the slide plate 4 can come close to or apart from the main device 2. On each lateral side of the slide plate 4, a paper adjuster 12 for arranging the end of the papers is provided upward from the slide plate 4. Further, on the slide plate 4, a paper presser 5 is provided; the paper presser 5 is movable in a vertical direction according to a rotational operation of a handle 6 and presses to hold the papers placed on the slide plate 4.

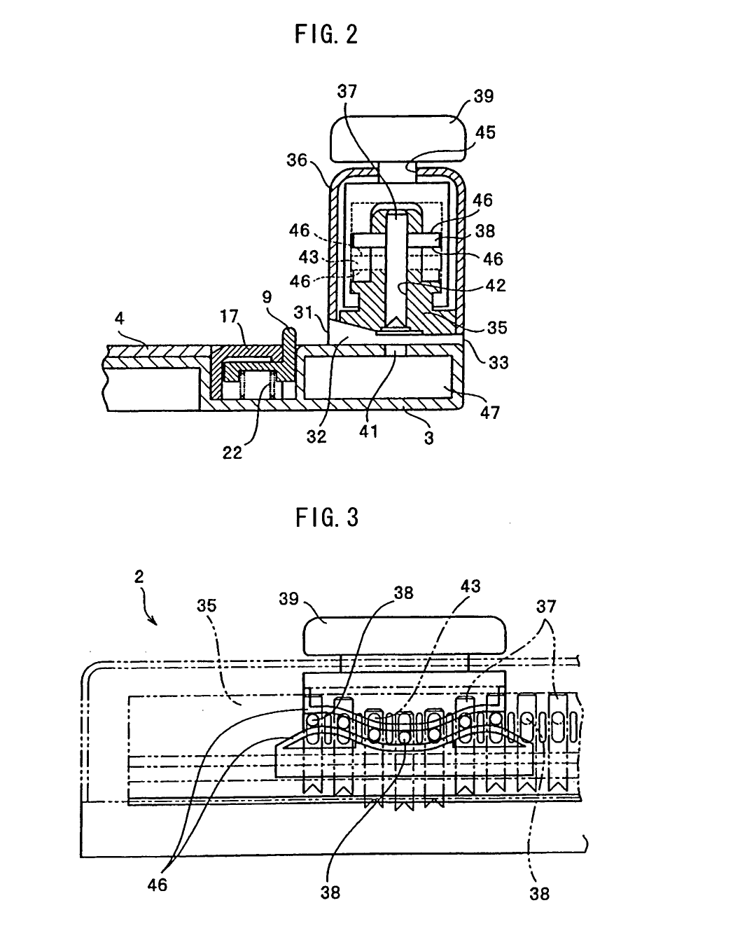

Between the main device 2 and the base 3, an insertion opening 31 is formed spread in a lateral direction, so that the papers placed on the slide plate 4 can be inserted. As shown in FIG. 2, between the main device 2 and the base 3, a space portion 32, penetrated in a lengthwise direction and spread in a lateral direction, is formed. The space portion 32 has the insertion opening 31 and a penetration opening 33 which is provided on the opposite side from the insertion opening 31, and the both openings 31, 33 are opened. The penetration opening 33 is also formed in a lateral direction.

Because of the above structure, any paper wastes accumulated in the space portion 32 can be easily eliminated from either the insertion opening 31 or the penetration opening 33 with any kinds of eliminators by introducing either from the insertion opening 31 or the penetration opening 33. Further, by introducing a paper into the insertion opening 31, the user can push out the wastes from the penetration opening 33. The wastes can be eliminated irrespective of a working condition of a punch 37.

As shown in FIG. 3, each lateral end of the main device 2 is placed on the base 3 while the intermediate portion of the main device 2, not including the lateral ends, is provided with a slide rail 35 spaced from the base 3. Here, in FIG. 3, although only one side of the slide rail is shown, the other side should be considered as the same.

In FIGS. 2 and 3, a punch support 36 is fitted to the slide rail 35. A slider 39 is slidably engaged with the slide rail 35, but the slide range of the slider 39 is restricted by a guide groove 45. See FIG. 1.

The slide rail 35, as shown in FIG. 2, is provided with a through hole 42, so that the punch 37 can be inserted thereinto. The number of the through hole 42 is decided based on a standard paper size to be used. In case of the A4, 30 through holes are needed while 26 in case of the B5. Further, on a side face of the slide rail 35, a long hole 43 is formed wherein an operation pin 38 provided on the punch 37 is guided by the long hole 43. The punch 37 is thus restricted to the vertical movement.

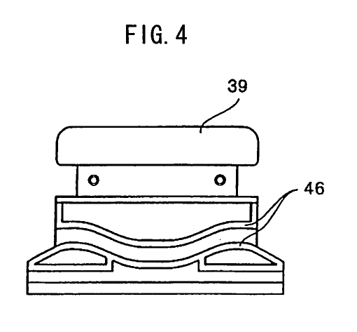

The slider 39 is provided with a cam surface 46. The cam surface 46 is, as shown in FIG. 4, in waveform. The operation pin 38 is guided from one end, along the cam surface 46, and the operation pin 38 is moved in a vertical direction along the cam surface 46 while the slider 39 is slided. See FIG. 3.

Specifically, by sliding the slider 39 in a lateral direction along the guide groove 45, the operation pin 38 is engaged with the cam surface 46, pressing down and up the punch 37. The cutting edge of the punch 37 pressed down along the cam surface 46 can be inserted through a punch hole 41 formed on the base 3.

With the above structure, the papers can be perforated with a given interval. Paper wastes produced by the punching operation can be received in a waste container 47 formed on the base 3. The paper wastes are dischargeable to the outside by removing an openable cover plate (not shown).

On the front side of the main device 2 (the insertion opening side), the base 3 on which the papers are placed is provided. On each side of the base 3, a side plate 11 is provided. On the front side of the main device 2, a paper adjuster 9 is also provided in such a manner that the paper adjuster 9 can be elevated from the base 3 in the vertical direction. An adjusting surface of the paper adjuster 9, where the end of the papers are adjusted, is formed running parallel to the direction in which the punch 37 is arranged.

The paper adjuster 9 is provided with a second spring 22 (described hereinafter), so that the paper adjuster 9 is energized upward, elevated from the upper surface of the base 3. On each side of the paper adjuster 9 is engaged with a pair of levers 10 provided in a lengthwise direction. The pair of the levers 10 are placed within grooves (hereinafter described) formed on the base 3 in a lengthwise direction, and energized upward with a spring.

As shown in, for example, FIG. 11, the paper adjuster 9 includes: an adjusting portion 9a to which the end of the papers are abutted and elevatable from the upper surface of the base 3; and a controlled portion 9b abutted to a back surface of a guide 17 with a spring force of the second spring 22. The guide 17 works not only for a guiding surface of the papers which are abutted to the paper adjuster 9, but also for a stopper against the controlled portion 9b.

The paper adjuster 9 engaged with the pair of the levers 10 is containable within the base 3 but energized upward with a first spring 21 and the second spring 22. The paper adjuster 9 and the levers 10 are thus movable in a vertical direction; the adjusting portion 9a of the paper adjuster 9 is elevated from the surface of the base 3 while keeping its posture perpendicular relative to the surface of the base 3.

The guide 17 was described as the stopper against the controlled portion 9b; however, another embodiment may be applied. The adjusting portion 9a may be extended more than the portion connected with the levers 10. An extended portion 9c (See FIG. 23) as a controlled member is extended within the base 3. In this case, the extended portion 9c, which is extended from the adjusting portion 9a, abuts to the edge faces of the grooves formed on both sides of the base 3. The extended portion 9c similar to the controlled portion 9b can control how far the adjusting portion 9a allows being extended from the surface of the base 3.

Some embodiments as to the extended portion 9c will be explained. For example, the height of the extended portion 9c may be set shorter than the height of the projected portion of the adjusting portion 9a. Here, the projected portion means the portion that is projected from the surface of the base 3. In this embodiment, the extended portion 9c is slidably provided within the grooves formed on both sides of the base 3. In another embodiment, the top surface of the extended portion 9c is set equal to the one of the adjusting portion 9a. Then, the height of the grooves formed on the both sides of the base 3 may be set equal to the height of the projected portion of the adjusting portion 9a.

With the above structure, the extended portion 9c abuts to the upper edge of the grooves with the spring force of the secondary spring 22, thereby enabling to control the amount of the projection of the adjusting portion 9a from the surface of the base 3. In addition, when the levers 10 are pressed, the extended portion 9c is also depressed against the spring force of the secondary spring 22, forcing the adjusting portion 9a to contain within the base 3.

On the base 3, adjacent to the paper adjuster 9, the guide 17, which guides the papers abutted to the paper adjuster 9, is provided. Some portions of the guide 17 is partially extended in a lengthwise direction, forming extended guides 17′. See FIG. 1. Each end of the extended guides 17′ forms a stopping portion 16, which restricts the movement of the slide plate 4. That is to say, the stopping portion 16 may be regarded as a secondary positioning means, which controls where the slide plate 4 should be stopped when moved toward the main device 2.

The stopping portion 16 may control the position of the slide plate 4 by making the portion abutted to one of engaged portions 19 formed on the slide plate 4. The engaged portion 19 abutted to the stopping portion 16 may be structured as a concaved bottom formed on the slide plate 4 in a lengthwise direction.

The stopping portion 16 may be formed on each lateral end of the guide 17 instead of the above formation. Specifically, as shown in FIG. 15, when the slide plate 4 is slided toward the main device 2, the tip of the slide plate 4 is made to abut to each lateral end of the guide 17, thus controlling where the slide plate 4 is stopped. In addition, on each lateral end of the guide 17, a guiding portion 20 upwardly slanted is provided so as to smoothly guide the papers onto the guide 17.

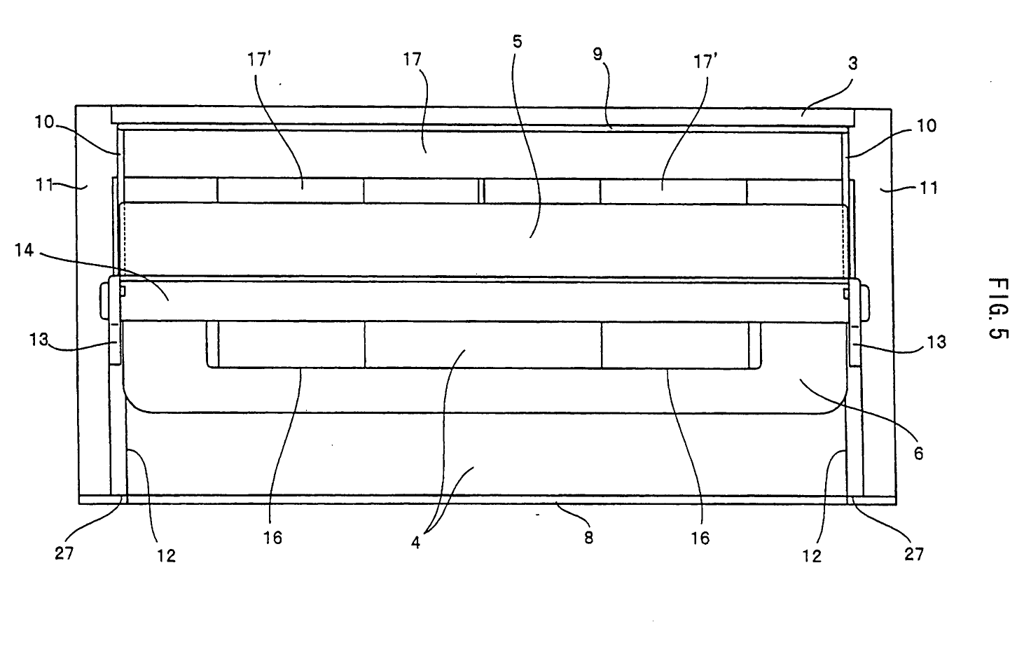

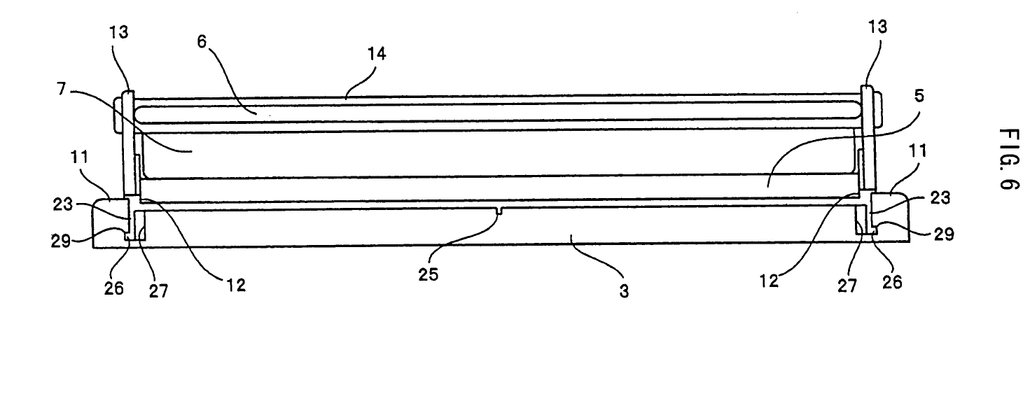

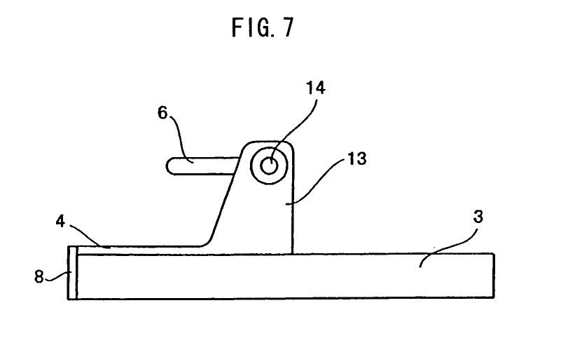

With reference to FIGS. 5 to 15, embodiments related to the slide plate 4 will be mainly discussed. The indication of the main device 2 is omitted in these figures. FIG. 5, FIG. 6 and FIG. 7 show a top view, a front view and a side view respectively.

As shown in FIG. 5, each of the levers 10 is engaged with each side of the paper adjuster 9. Each of the levers 10 is contained within each of grooves 27 formed on the base 3 in a lengthwise direction. The levers 10 are energized upward by the first spring 21. The paper adjuster 9, in its intermediate position, is energized with the second spring 22 also in the upward direction. The paper adjuster 9 and the levers 10 are containable within the base 3, and at the same time are movable in a vertical direction.

As shown in FIG. 6, inside of the grooves 27 can be used as a guiding groove for the slide plate 4. Each of flanged portions 23 formed downward from each lateral end of the slide plate 4 is provided with a slide rib 26. Each of the slide rib 26 is slidably engaged with one of guide grooves 29 formed in the grooves 27.

As shown in FIGS. 6 and 7, flanged sections 13 are upwardly provided on the both sides of the slide plate 4. Between the flanged sections 13, a spindle 14 is rotatably provided. A handle 6 and a lock plate 7 are assembled with a given angle relative to the spindle 14 in a circumferential direction, with a given distance. By employing the spindle 14, the lock plate 7 and the handle 6, the paper presser 5 can press the papers on the slide plate 4 or release therefrom.

By rotating the handle 6 (the spindle 14), an operational position and a non-operational position can be switched. The operational position means the condition that the lock plate 7 presses the paper presser 5 toward the slide plate 4. And, the non-operational position means the condition that the handle 6 is re-rotated to an initial position so that the paper presser 5 is released from the pressed state. FIG. 7 shows the operational position.

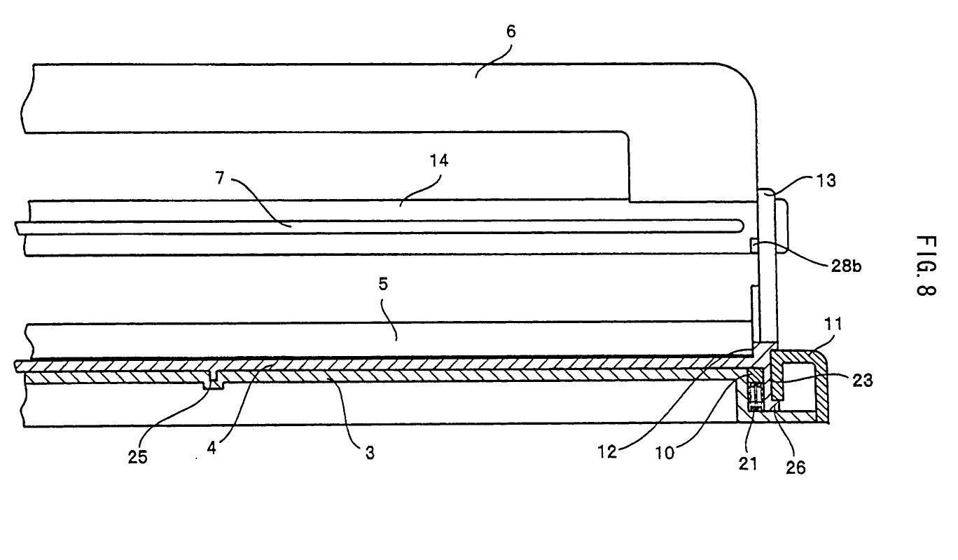

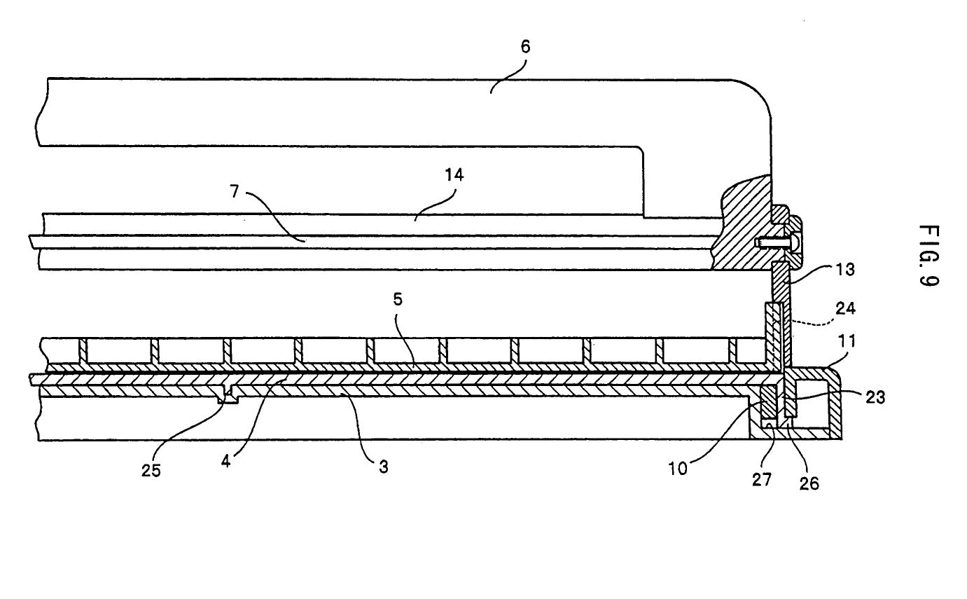

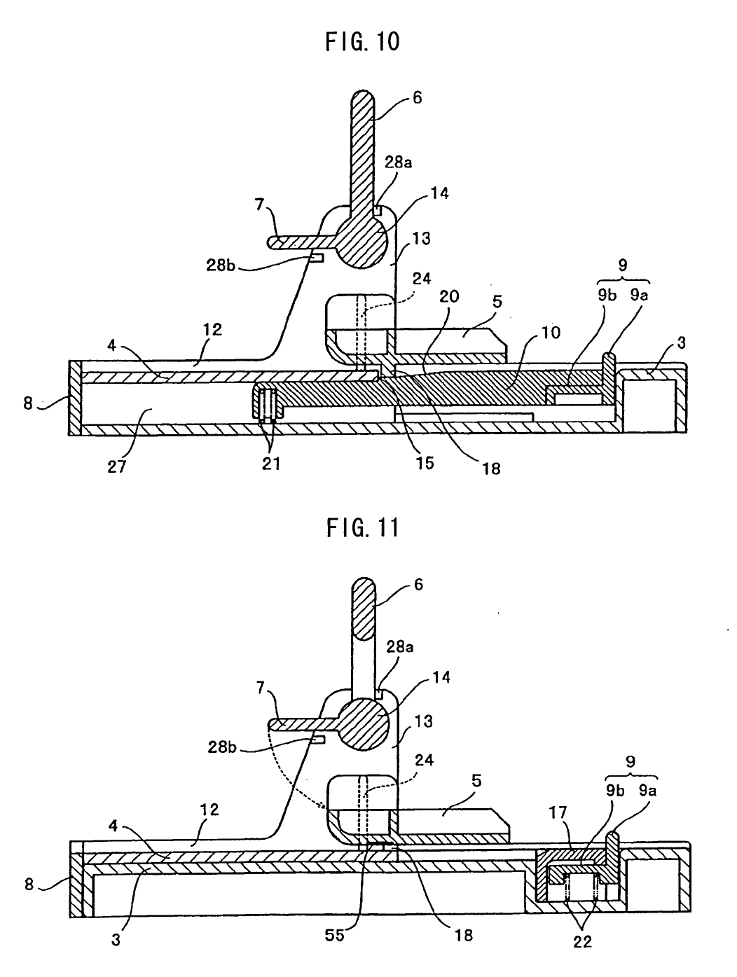

Next, the embodiment 1 will be explained with reference to FIGS. 8 to 15 (FIGS. 8 and 9 show the non-operational position). In FIGS. 8 and 10, the lever 10 is energized upward by the first spring 21, abutting to the back surface of the slide plate 4. On the upper surface of the lever 10, a step 15 is formed, which works as an engaging portion relative to the end of the slide plate 4.

Specifically, the step 15 functions as a first position control means controlling an initial position of the slide plate 4. The slide plate 4 fixed in the initial position by the step 15 can control the position of the papers placed on the slide plate 4; the rear end of the slide plate 4 also abuts to a surface 8 thus restricting the backward movement of the slide plate 4.

As explained, the surface 8 restricts the backward movement of the slide plate 4. Accordingly, the slide plate 4 in the initial position, positioned between the step 15 and the surface 8, is fixed on the base 3.

As shown in FIG. 9, on the inner surface of the flanged section 13 provided upward relative to the slide plate 4, a rib 24 is formed in a vertical direction. The movement of the paper presser 5 is thus restricted by the rib 24. It was explained that the slide rib 26 formed on the flanged portion 23 provided downward from the side edge of the slide plate 4 is slidably engaged with the guide groove 29 formed in the groove 27. Here, as shown in FIGS. 8 and 9, it is possible to use space formed between the side plate 11 and the bottom surface of the base 3 as the guide groove in which the slide rib 26 is slidably engaged.

As shown in FIG. 10 and 11, the rotatable range of the handle 6 is restricted with handle stoppers 28a, 28b formed on the flanged section 13. Referring to FIG. 11, an anti-slipped material 55 may be applied at the bottom surface of the paper presser 5, effectively preventing the slippage of the papers when pressed by the paper presser 5. The paper adjuster 9 is formed approximately L-shape in section, and one portion of the paper adjuster 9 is abutted to the back surface of the guide 17 by the spring force of the second spring 22. The paper adjuster 9 is thus prevented form being fell off from the base 3.

The paper adjuster 9 (approximately cup-shape in a top view) and the pair of the levers 10 are containable within the base 3 and projectable upward by the spring force of the both the first spring 21 and the second spring 22. The paper adjuster 9 and the levers 10 are thus movable in a vertical direction relative to the surface of the base 3. Accordingly, the surface of the adjusting portion 9a to which the papers are abutted can keep perpendicular relative to the surface of the base 3.

As also shown in FIG. 10, a projection 18 is formed on the back surface of the paper pressure 5, which abuts to the upper surface of the lever 10, forming a space between the paper presser 5 and the slide plate 4 for the insertion of the papers.

The projection 18 is positioned between the back surface of the paper presser 5 and the slide plate 4 creating a space so that the papers are smoothly inserted thereinto. For making slide plate 4 surely abutted to the projections 18, the slide plate 4 may partially have a cutout. In this case, the cutout should be formed as not hampering the movement of the projection 18.

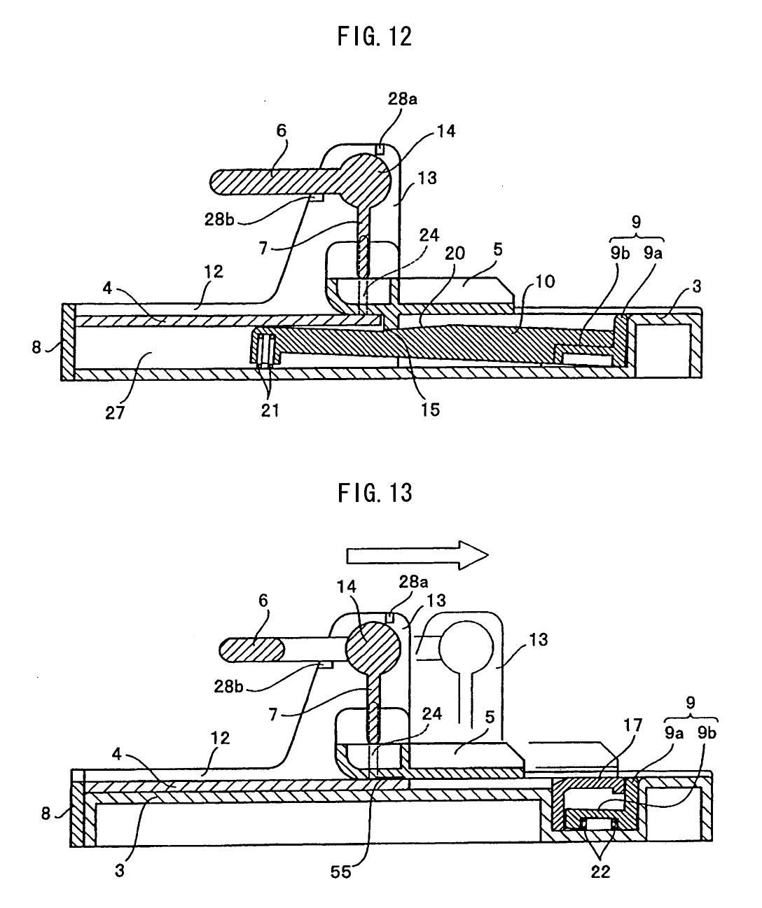

In FIGS. 12 to 15, the handle 6 rotates, so that the lock plate 7 presses the paper presser 5 toward the slide plate 4. As shown in FIG. 12, the projection 18 moves the lever 10 downward against the spring force of the first spring 21, disengaging the end of the slide plate from the step. At the same time, as also shown in FIG. 13, according to the downward movement of the lever 10, the adjusting portion 9a of the paper adjuster 9 is made to be contained within the base 3.

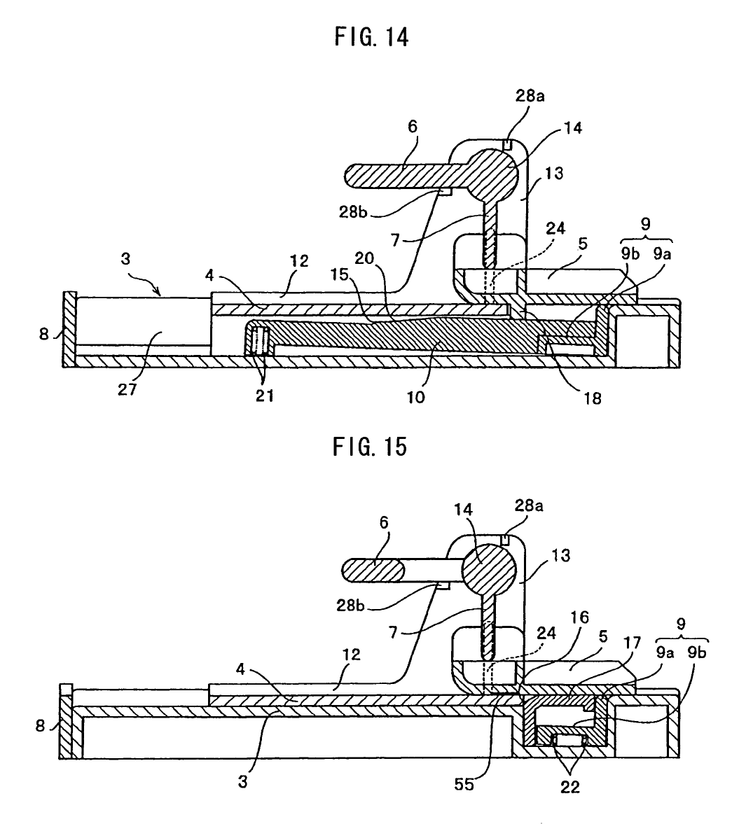

Accordingly, the lever 10 maintains its downwardly pressed position by means of the projection 18. The slide plate 4 can thus freely move toward the paper adjuster 9, as shown by an arrow in FIG. 13. While the slide plate 4 is slided, the projection 18 pressing the lever 10 keeps its horizontal height. Thus, the lever 10 maintains its downwardly pressed position regardless of the position of the slide plate 4. See FIG. 14.

The lever 10 includes the guiding portion 20 upwardly slanted from the step 15 to the paper adjuster 9. See FIG. 12. When the slide plate 4 is moved toward the paper adjuster 9, the projection 18 passes through the guiding portion 20, whereby the back surface of the slide plate 4 abuts to the lever 10.

In the above condition, even if the handle 6 is rotated to switch from the operational condition to the non-operational condition, the back surface of the slide plate 4 keeps abutment to the lever 10. Accordingly, the lever 10 is successfully pressed by the back surface of the slide plate 4; the adjusting portion 9a of the paper adjuster 9 is also prevented from being projected from the base 3.

As shown in FIGS. 14 and 15, when the slide plate 4 is moved to the given position that the papers are perforated with the main device 2, the engaged portions 19 of the slide plate 4 abut to the stopping portions 16.

When the slide plate 4 is positioned by abutting to the stopping positions 16, the desired position of the papers can be set to the main device 2. In the position, the slider 39 placed on the main device 2 is slided, enabling to perforate given numbers of holes onto the papers.

The stopping positions 16 may be formed on the upper surface of the lever 10. In this case, even when the lever 10 is pressed downward, the stopping positions 16 are not contained within the base 3 thereby enabling to abut to the slide plate 4 moved.

Accordingly, in the embodiment 1 of the present invention, the user can visually confirm in advance the portions of the papers to be processed while making the papers abutted to the paper adjuster 9. Further, since the papers are placed on and fixed to the slide plate 4 (stayed in the initial position), the papers, regardless of their standard paper sizes, can be well arranged thereon. Furthermore, because the slide plate 4, on which the papers are placed, is simply moved to abut the stopping portions 16, the user can well match the perforated position of the papers with the process position of the main device 2.

Still further, the slide plate 4 can be released from the initial position by simply rotating the handle 6; the paper adjuster 9 is made to contain within the base 3 according to the release of the slide plate 4. The paper adjuster 9 would never hamper the sliding movement of the slide plate 4.

In addition, since the insertion opening 31 and the penetration opening 33 of the main device 2 are communicated with each other, paper wastes accumulated in the space portion 32 of the main device 2 can be easily eliminated therefrom.

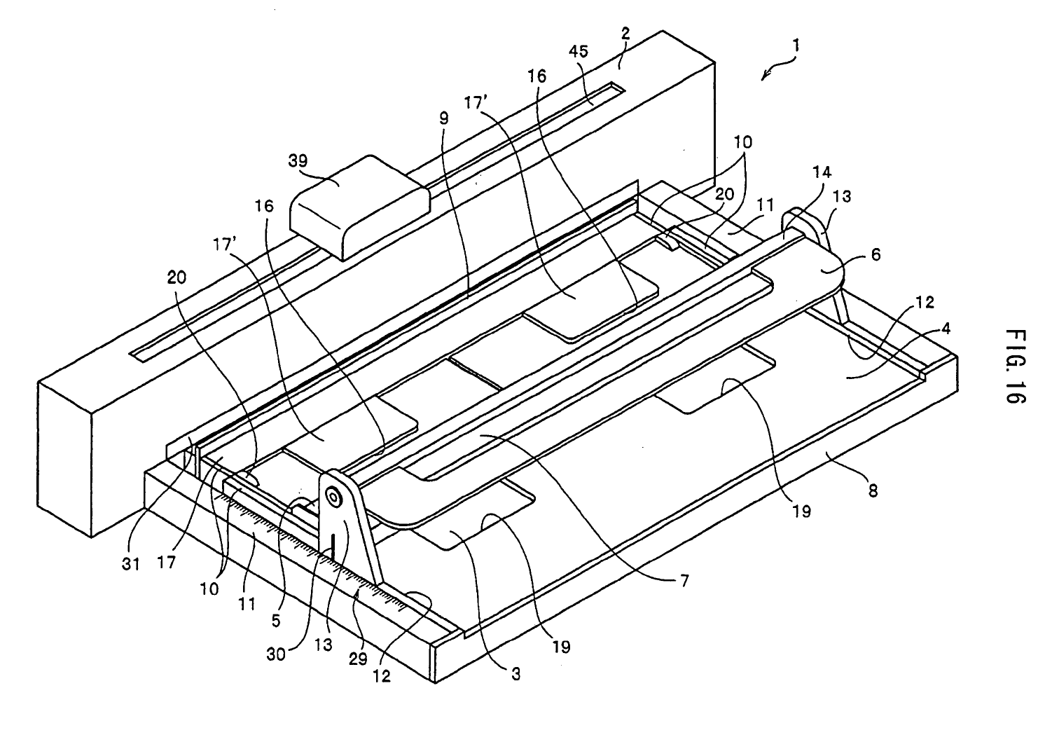

Next, the embodiment 2 of the present invention will be described with reference to FIGS. 16 to 19. Same reference numbers used in the embodiment 1 will be applied to the embodiment 2 if denoting identical parts, and the explanation thereto will be omitted.

In the embodiment 2, a scale 29 is formed on the side plates 11. See FIG. 16. The scale 29 is formed, running parallel to the direction in which the slide plate 4 is moved. On the outer side surface of the flanged section 13 provided upward on the slide plate 4, a reference line 30 is provided. By matching the reference line 30 to a certain mark on the scale 29, the slide plate 4 can be positioned, keeping a certain distance from the paper adjuster 9.

The slide plate 4 is moved to abut to the stopping portions 16 as described above. The distance therebetween can be determined by applying the scale 29. By arbitrarily setting the reference line 30 to a certain mark on the scale, the user can freely determine the position of the edge of the papers relative to the slide plate 4.

Even if the papers are not properly arranged on the slide plate 4, the end of the papers can be projected outward from the penetration opening 33 through the space portion 32 of the main device 2 into which the papers are inserted. With this feature, perforation can be properly performed on the papers.

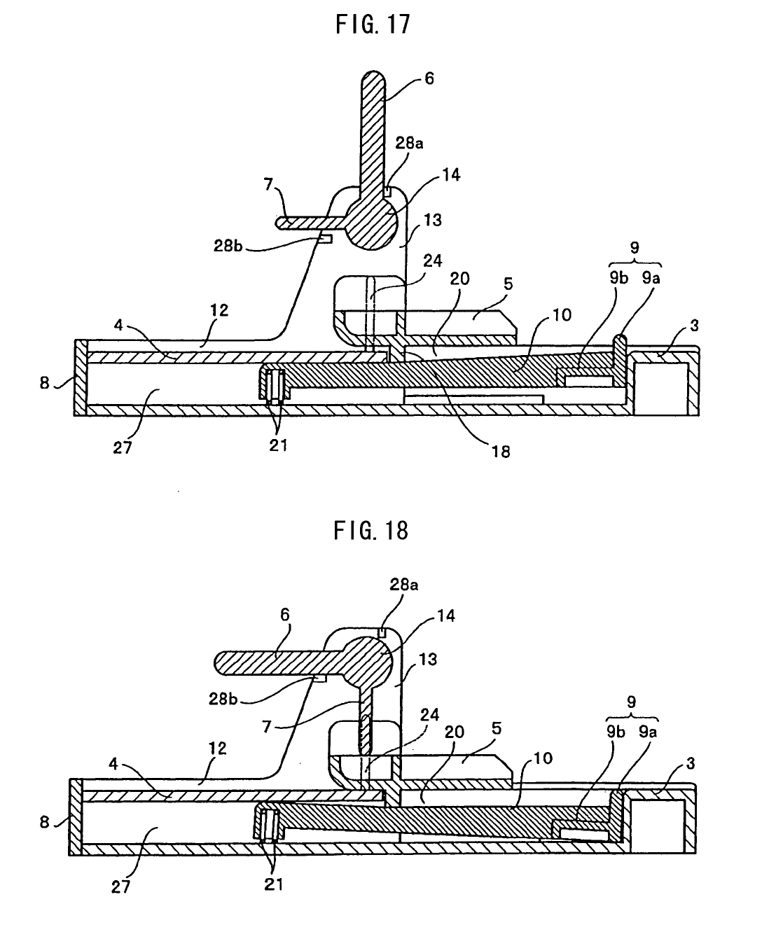

FIGS. 17 and 18, as the same with FIGS. 10 and 12 in the embodiment 1, show sectional view in a lengthwise direction where the lever 10 is provided. In FIGS. 10 and 12 in the embodiment 1, the step 15 abutted to the end of the slide plate 4 is formed on the lever 10. On the other hand, in the second embodiment, as shown in FIGS. 17 and 18, the step 15 is not formed on the lever 10. Accordingly, the slide plate 4 can freely move on the base 3, and is positioned by the scale 29. This also means that the end of the slide plate 4 is not restricted by the lever 10, whereby the slide plate 4 can also freely move on the slide plate 10.

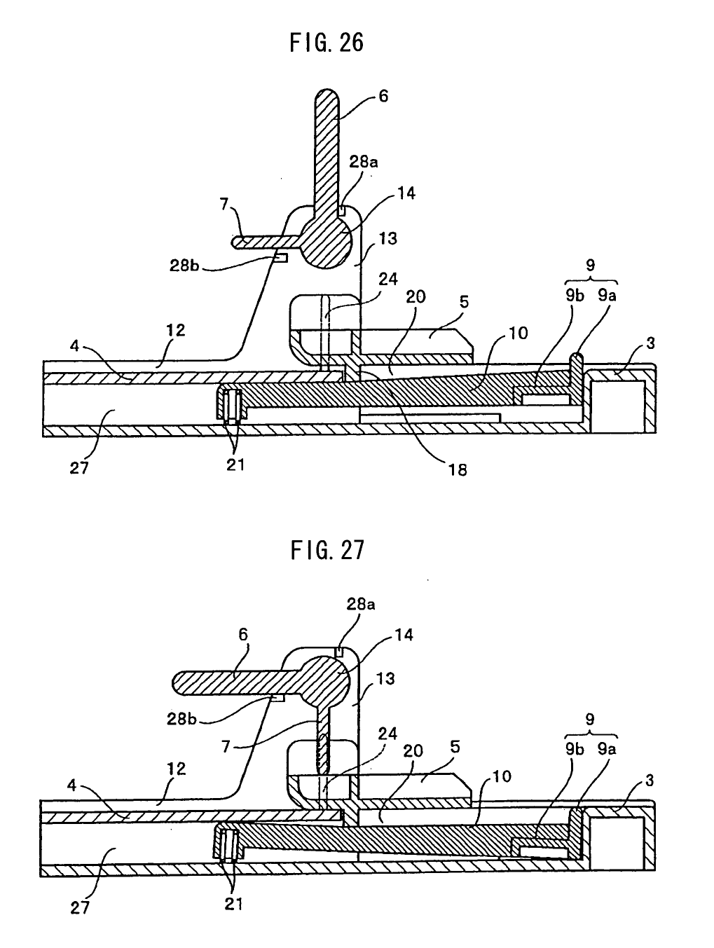

Furthermore, as shown in FIGS. 26 and 27, the surface 8 may be eliminated. The slide plate 4 can thus freely move backward toward the back side of the base 3, whereby the distance to the paper adjuster 9 can be arbitrarily determined. Here, for preventing the slide plate 4 from being pulled off, any kinds of stopping mechanisms for the slide plate 4 (not shown) may be formed on the base 3. Conventional stopping mechanisms may be also applied.

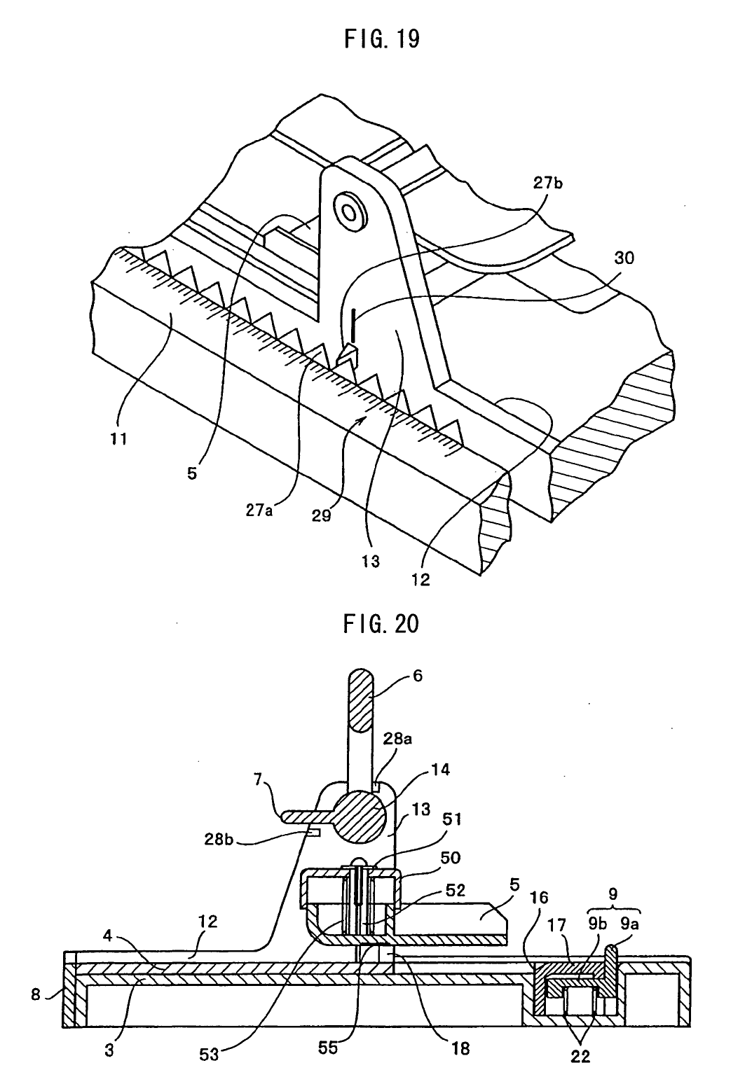

Further, as shown in FIG. 19, on the side of the side plate 11, a plurality of ratchet teeth 27a may be formed. On the surface of the slide plate 4, facing to the ratchet teeth 27a, a plurality of or a single of ratchet claw(s) 27b may be formed, so that the ratchet teeth 27 and the ratchet claw are engaged with each other. The ratchet claw 27b may be a member with a spring, so that it is energized toward the ratchet teeth 27a, but containable within the slide plate 4 with a certain pressure.

By providing the ratchet teeth 27a and the ratchet claw 27b, the slide plate 4 can be set in the initial position and prevented from being displaced. While the slide plate 4 is slided in a lengthwise direction, the ratchet claw 27b is contained within the slide plate 4, whereby there would be no hamper to position the slide plate 4 in a desired position.

Further, in case that the slide plate 4, on which the papers are fixed, moves toward the main devices 2, substantially no power would be needed to place the ratchet claw 27b within the slide plate 4. It is also possible to provide a mechanism that when setting the slide plate 4 in the initial position, the ratchet 27b is temporarily contained within the slide plate 4.

The position of the slide plate 4 relative to the paper adjuster 9 can be determined by the position of the ratchet teeth 27; the narrower the working pitches of the ratchet teeth 27a are, the more accurately the slide plate 4 can be set. Furthermore, the ratchet teeth 27a and the ratchet claw 27b may be formed inversely; that is, on the slide plate 4 and on the side plate 11, respectively. The ratchet teeth 27a may be formed at any portions as long as they are formed on the track on which the slide plate 4 moves.

Next, the embodiment 3 of the present invention will be explained with reference to FIGS. 20 to 22. Same reference numeral as embodiments 1 and 2 will be applied if used identically. Some of the explanations may be omitted if previously explained.

In the embodiment 3, the paper presser 5 is energized by a spring force of a paper presser spring 53. On the upper surface of the paper presser 5, a guide support 52 is provided upwardly. The paper presser 5 is slidable along the guide support 52 in a vertical direction. Between a cover 50 and the paper presser 5, the paper presser spring 53 is provided, thereby pressing the paper presser 5 toward the slide plate 4 by the spring force thereof. For preventing the guide support 52 from being come out from the cover 50, a guide support stopper 51 is provided at the end of the guide support 52.

As shown in FIG. 20, in the condition that the lock plate 7 does not press the cover 50 (non-operational position), the paper presser 5 is energized upward by the projection 18 provided on the back surface of the paper presser 5, and by the lever (not shown) energized upward, pressing the paper presser 5. The space is thus formed between the paper presser 5 and the slide plate 4, so that the papers can be inserted therebetween. Further, the cover 50 is abutted to the guide support stopper 51 provided at the guide support 52, by means of the spring force of the paper presser spring 53.

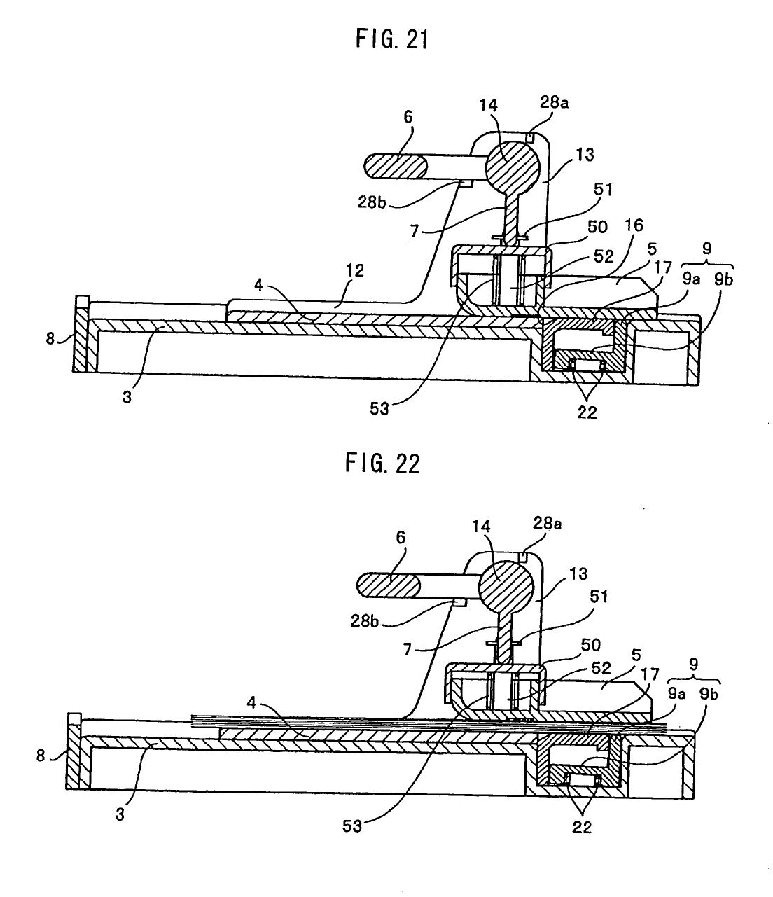

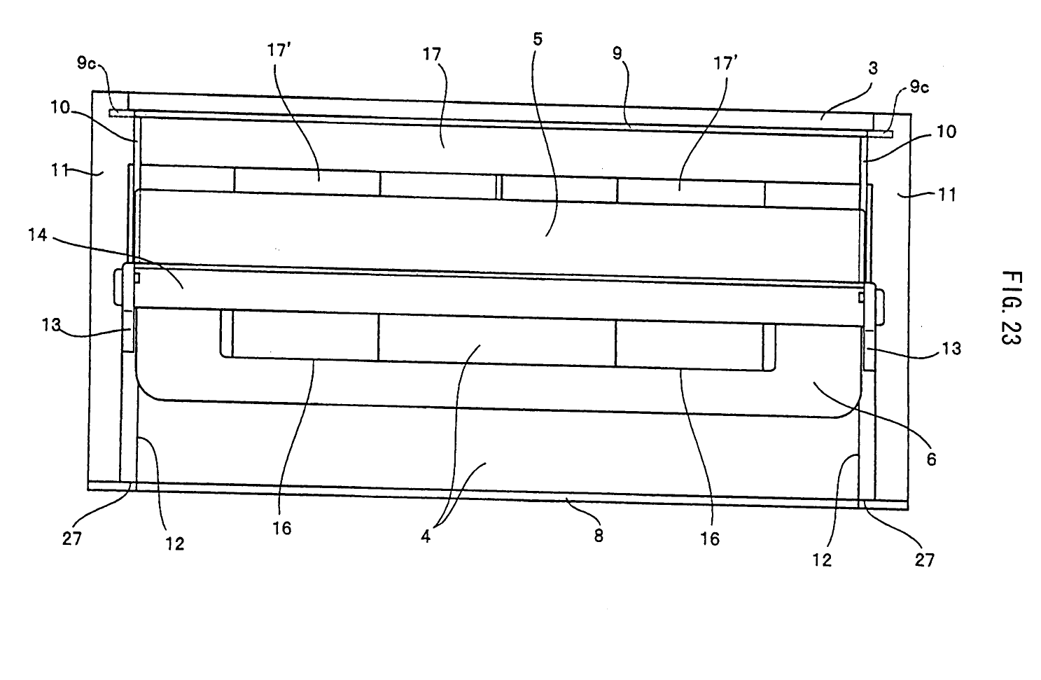

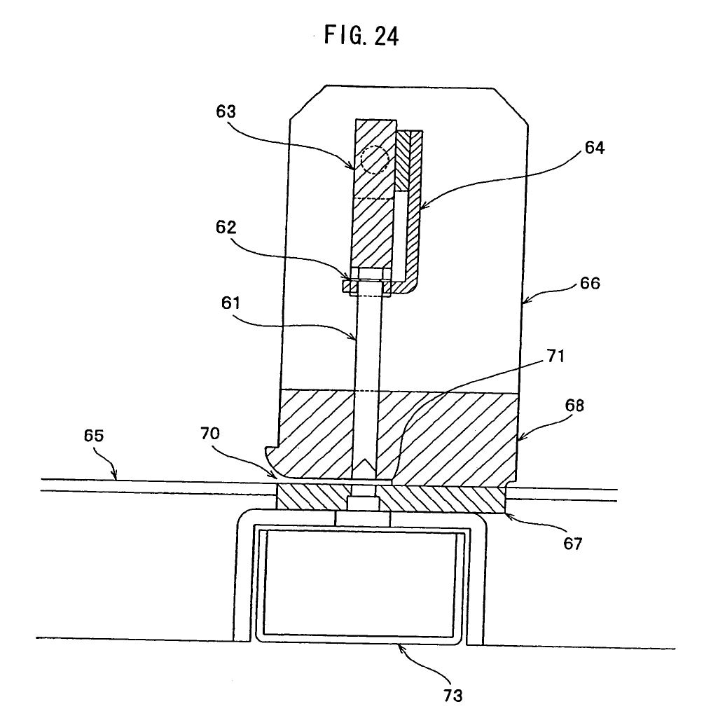

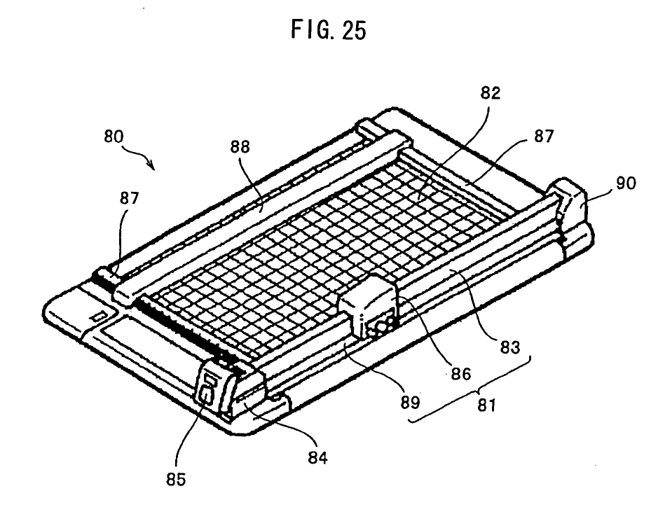

As shown in FIG. 21, by pressing the cover 50 via the lock plate 7 (operational position), the paper presser spring 53 is made to be compressed, increasing the pressing force of the paper presser 5 toward the slide plate 4. In FIG. 22, the papers, in which the edge thereof is properly arranged with the paper adjuster 9, are inserted between the paper presser 5 and the slide plate 4, then the handle 6 is operated. With these operations, the papers are firmly pressed and held by the paper presser 5 with the pressing force of the paper presser spring 53. Even if only a piece of paper is placed between the paper presser 5 and the slide plate 4, the piece of paper can be firmly held by a given pressing force.

What is claimed is:

1. A paper perforator mechanism comprising:
a base;
a paper processing main device working for cutting, perforating or stapling to papers, wherein the paper processing main device is placed on the base;
a paper adjuster projectable from the upper surface of the base, wherein the end of the papers, where facing to the paper processing main device, is abutted to the paper adjuster;
a slide plate slidable on the base;
a paper presser provided on the slide plate and pressable to the papers placed on the side plate;
a first positioning means setting an initial position of the slide plate on the base relative to the paper adjuster;
a depressing means depressing the paper adjuster to contain within the base;
a sliding member moving the slide plate on which the papers are fixed, toward the paper processing main device; and
a second positioning means setting the position of the slide plate on the base in a condition that the papers are ready for being processed.

2. A paper perforator mechanism according to claim 1, wherein the first positioning means include: a position controlling means fixing the slide plate in the initial position; and a releasing means releasing the slide plate from the initial position.

3. A paper perforator mechanism according to claim 2, wherein the position controlling means is provided with a step formed on a lever which is connected with the paper adjuster, wherein the slide plate is fixed in the initial position by abutting the end of the slide plate, where facing to the paper processing main device, to the step.

4. A paper perforator mechanism according to claim 3, wherein the lever is energized upward with a first elastic member; the releasing means is provided with a projection placed downward from the paper presser; the surface of the lever, on which the step is provided, is pressed downward against the spring force of the first elastic member with the projection so as to maintain non-engagement between the step and the slide plate.

5. A paper perforator mechanism according to claim 4, wherein the paper adjuster is provided with an adjusting portion projectable from the surface of the base, and a controlled portion which controls an amount of the projection of the adjusting portion, wherein the controlled portion is abutted to a guide provided on the base by the spring force of the second elastic member; and the releasing means concurrently serves for the depressing means wherein by depressing the upper surface of the lever with the projection while depressing the second elastic member, the abutment between the controlled portion and the guide is released, making the paper adjuster contained within the base.

6. A paper perforator mechanism according to claim 2, wherein the position controlling means is formed as a surface provided at the end of the base where opposite to the place that the paper processing main device is provided, wherein the slide plate is fixed in the initial position by abutting the end thereof to the surface.

7. A paper perforator mechanism according to claim 3 wherein the position controlling means is formed as a surface provided at the end of the base where opposite to the place that the paper processing main device is provided, wherein the slide plate is fixed in the initial position by abutting the end thereof to the surface.

8. A paper perforator mechanism according to claim 4 wherein the position controlling means is formed as a surface provided at the end of the base where opposite to the place that the paper processing main device is provided, wherein the slide plate is fixed in the initial position by abutting the end thereof to the surface.

9. A paper perforator mechanism according to claim 5 wherein the position controlling means is formed as a surface provided at the end of the base where opposite to the place that the paper processing main device is provided, wherein the slide plate is fixed in the initial position by abutting the end thereof to the surface.

10. A paper perforator mechanism according to claim 1, wherein the first positioning means is provided as a scale, setting the paper adjuster as a datum starting point, and running parallel to the direction in which the slide plate is moved.

11. A paper perforator mechanism according to claim 10, wherein a plurality of ratchet teeth running parallel to the scale and a ratchet claw are provided facing to each other, either on the base or the side plate, wherein the ratchet teeth and the ratchet claw are engageable with each other by making the ratchet claw projectable from the base or the side plate.

12. A paper perforator mechanism according to claim 1 wherein the second positioning means is provided as a stopping portion formed on a given portion of the base, wherein the slide plate is positioned by abutting the end thereof, where facing to the paper processing main device, to the stopping portion.

13. A paper perforator mechanism according to claim 2 wherein the second positioning means is provided as a stopping portion formed on a given portion of the base, wherein the slide plate is positioned by abutting the end thereof, where facing to the paper processing main device, to the stopping portion.

14. A paper perforator mechanism according to claim 3 wherein the second positioning means is provided as a stopping portion formed on a given portion of the base, wherein the slide plate is positioned by abutting the end thereof, where facing to the paper processing main device, to the stopping portion.

15. A paper perforator mechanism according to claim 4 wherein the second positioning means is provided as a stopping portion formed on a given portion of the base, wherein the slide plate is positioned by abutting the end thereof, where facing to the paper processing main device, to the stopping portion.

16. A paper perforator mechanism according to claim 5 wherein the second positioning means is provided as a stopping portion formed on a given portion of the base, wherein the slide plate is positioned by abutting the end thereof, where facing to the paper processing main device, to the stopping portion.

17. A paper perforator mechanism according to claim 6 wherein the second positioning means is provided as a stopping portion formed on a given portion of the base, wherein the slide plate is positioned by abutting the end thereof, where facing to the paper processing main device, to the stopping portion.

18. A paper perforator mechanism according to claim 10 wherein the second positioning means is provided as a stopping portion formed on a given portion of the base, wherein the slide plate is positioned by abutting the end thereof, where facing to the paper processing main device, to the stopping portion.

19. A paper perforator mechanism according to claim 11 wherein the second positioning means is provided as a stopping portion formed on a given portion of the base, wherein the slide plate is positioned by abutting the end thereof, where facing to the paper processing main device, to the stopping portion.

20. A paper perforator mechanism according to claim 1, wherein the sliding means includes the mechanism that a lock plate is shifted downward to press the paper presser toward the slide plate, and that the slide plate pressed by the paper presser is moved.

21. A paper perforator mechanism according to claim 2, wherein the sliding means includes the mechanism that a lock plate is shifted downward to press the paper presser toward the slide plate, and that the slide plate pressed by the paper presser is moved.

22. A paper perforator mechanism according to claim 3, wherein the sliding means includes the mechanism that a lock plate is shifted downward to press the paper presser toward the slide plate, and that the slide plate pressed by the paper presser is moved.

23. A paper perforator mechanism according to claim 4, wherein the sliding means includes the mechanism that a lock plate is shifted downward to press the paper presser toward the slide plate, and that the slide plate pressed by the paper presser is moved.

24. A paper perforator mechanism according to claim 5, wherein the sliding means includes the mechanism that a lock plate is shifted downward to press the paper presser toward the slide plate, and that the slide plate pressed by the paper presser is moved.

25. A paper perforator mechanism according to claim 6, wherein the sliding means includes the mechanism that a lock plate is shifted downward to press the paper presser toward the slide plate, and that the slide plate pressed by the paper presser is moved.

26. A paper perforator mechanism according to claim 10, wherein the sliding means includes the mechanism that a lock plate is shifted downward to press the paper presser toward the slide plate, and that the slide plate pressed by the paper presser is moved.

27. A paper perforator mechanism according to claim 11, wherein the sliding means includes the mechanism that a lock plate is shifted downward to press the paper presser toward the slide plate, and that the slide plate pressed by the paper presser is moved.

28. A paper perforator mechanism according to claim 12, wherein the sliding means includes the mechanism that a lock plate is shifted downward to press the paper presser toward the slide plate, and that the slide plate pressed by the paper presser is moved.
